(19) United States
(12) Patent Application Publication
(10) Pub. No.: US 2025/0370117 A1
(43) Pub. Date: Dec. 4, 2025

(54) OBJECT TRACKING DEVICE

(71) Applicant: DENSO CORPORATION, Kariya-city (JP)

(72) Inventors: Yusuke AKAMINE, Nisshin-city (JP); Takuya TAKAYAMA, Kariya-city (JP)

(21) Appl. No.: 19/302,715

(22) Filed: Aug. 18, 2025

Related U.S. Application Data
(63) Continuation of application No. PCT/JP2024/005285, filed on Feb. 15, 2024.

(30) Foreign Application Priority Data
Feb. 20, 2023 (JP) 2023-024583

(51) Int. Cl. G01S 13/42

(52) U.S. Cl. CPC G01S 13/42

(57) ABSTRACT

An object tracking device according to one aspect of the present disclosure includes a sensor part, a contour calculator, a prediction value calculator, an association section, and an estimation section. The contour calculator calculates a predicted contour based on a predetermined shape model of an object and an estimation value calculated in the past. The prediction value calculator calculates a plurality of prediction values located in a prescribed region on and/or in the predicted contour, independently from a plurality of observed values acquired.

### CROSS-REFERENCE TO RELATED APPLICATION

The present application is a continuation application of International Application No. PCT/JP2024/005285, filed on Feb. 15, 2024, which claims priority to Japanese Patent Application No. 2023-024583, filed on Feb. 20, 2023. The contents of these applications are incorporated herein by reference in their entirety.

### BACKGROUND

### Technical Field

The present disclosure relates to a technique for tracking an object around a mobile object.

### Background Art

In extended object tracking (hereinafter, EOT) of the prior art, the motion state of a target is estimated in chronological order by associating a prediction value on a predicted contour of the target with an observed value under the assumption that a reflected signal received by a radar device is generated on the contour of the target.

### SUMMARY

In the present disclosure, provided is an object tracking device as the following.

The object tracking device includes a sensor part, a contour calculator, a prediction value calculator, an association section, and an estimation section. The contour calculator calculates a predicted contour based on a predetermined shape model of an object and an estimation value calculated in the past. The prediction value calculator calculates a plurality of prediction values located in a prescribed region on and/or in the predicted contour, independently from a plurality of observed values acquired.

### BRIEF DESCRIPTION OF THE DRAWINGS

FIG. 1 is a block diagram illustrating a hardware configuration of an object tracking device according to a first embodiment.

FIG. 2 is a block diagram illustrating a functional configuration of the object tracking device according to the first embodiment.

FIG. 3 is a diagram illustrating one example of the position of a vehicle at which a sensor part of the first embodiment is mounted and the detection region of the sensor part.

FIG. 4 is a diagram illustrating another example of the position of a vehicle at which the sensor part of the first embodiment is mounted and the detection region of the sensor part.

FIG. 5 is a flowchart illustrating a tracking process performed by the object tracking device according to the first embodiment.

FIG. 6 is a flowchart illustrating a prediction value calculation process performed by the object tracking device according to the first embodiment.

FIG. 7 is a flowchart illustrating an estimation process performed by the object tracking device according to the first embodiment.

FIG. 8 is a diagram illustrating a predicted contour, observed values, and prediction values in the first embodiment.

FIG. 9 is a diagram illustrating association of one prediction value with a plurality of observed values in the first embodiment.

FIG. 10 is a diagram illustrating a state in which the prediction values are calculated in a direct reflection area on an elliptic contour in the first embodiment.

FIG. 11 is a diagram illustrating a state in which the prediction values are calculated in a direct reflection area on a rectangular contour in the first embodiment.

FIG. 12 is a diagram illustrating a state in which the prediction values are, in the first embodiment, calculated in a direct reflection area on an elliptic contour when an object is irradiated from a rear thereof with sensor waves.

FIG. 13 is a diagram illustrating a state in which the prediction values are, in the first embodiment, calculated in a direct reflection area on an elliptic contour when an object is irradiated from a side thereof with sensor waves.

FIG. 14 is a diagram illustrating a state in which the positional intervals between the prediction values are narrower the nearer the prediction values are to the center of a prescribed region on an elliptic contour in the first embodiment.

FIG. 15 is a diagram illustrating a state in which the prediction values are, in the first embodiment, calculated on and in an elliptic contour when an object is irradiated from a rear thereof with sensor waves.

FIG. 16 is a flowchart illustrating a prediction value calculation process performed by an object tracking device according to a second embodiment.

FIG. 17 is a flowchart illustrating an estimation process performed by the object tracking device according to the second embodiment.

FIG. 18 is a flowchart illustrating a prediction value calculation process performed by an object tracking device according to a third embodiment.

### DETAILED DESCRIPTION OF THE PREFERRED EMBODIMENTS

In extended object tracking (hereinafter, EOT) described in Non-Patent Literature 1, the motion state of a target is estimated in chronological order by associating a prediction value on a predicted contour of the target with an observed value under the assumption that a reflected signal received by a radar device is generated on the contour of the target. Specifically, in the EOT, intersections between a plurality of lines and a predicted contour are calculated as prediction values. The plurality of lines pass through the center of the predicted contour and a plurality of observed values in one-to-one correspondence with the lines. Each of the plurality of prediction values calculated is associated with an observed value on the same line as the prediction value.
[Non-PTL 1] TOKIZAWA, Soichiro, YONEDA, Keisuke, SUGANUMA, Naoki, Stable and Real-Time Extended Object Tracking for Autonomous Driving, Transactions of Society of Automotive Engineers of Japan, September 2021, Vol. 52, No. 5

As a result of thorough study, the inventor has found a problem with the EOT in which a prediction value is calculated based on an observed value, and therefore, once a prediction value is associated with an incorrect observed value, the estimation of the motion state of the target is continuously affected by the incorrect association. The problem leads to a problem that the accuracy of estimating the position of a target is decreased.

One aspect of the present disclosure is desired to be able to provide an object tracking device capable of suppressing the decrease of accuracy of estimating the position of a target.

An object tracking device according to one aspect of the present disclosure includes a sensor part, a contour calculator, a prediction value calculator, an association section, and an estimation section. The sensor part is mounted to a mobile object. The sensor part sends and receives a sensor wave to and from around the mobile object, and acquires a plurality of observed values. The plurality of observed values correspond to mutually different reflection positions. The contour calculator calculates a predicted contour based on a predetermined shape model of an object and an estimation value calculated in the past. The estimation value is an estimated value that represents a state of a target including a position and a direction of the object. The predicted contour is a predicted value representing a current contour of the target. The prediction value calculator calculates a plurality of prediction values located in a prescribed range on and/or in the predicted contour, independently from the plurality of observed values acquired by the sensor part. The association section associates each of the plurality of prediction values with at least one of the plurality of observed values, and thus produces a plurality of association sets. The estimation section calculates the current estimation value based on the plurality of association sets produced by the association section.

In the object tracking device according to the one aspect of the present disclosure, a plurality of prediction values are calculated independently from a plurality of observed values. Accordingly, continuation of incorrect association between a prediction value and an observed value is suppressed, and the decrease of accuracy of estimating the position of a target can be suppressed.

### First Embodiment

### 1. Configuration

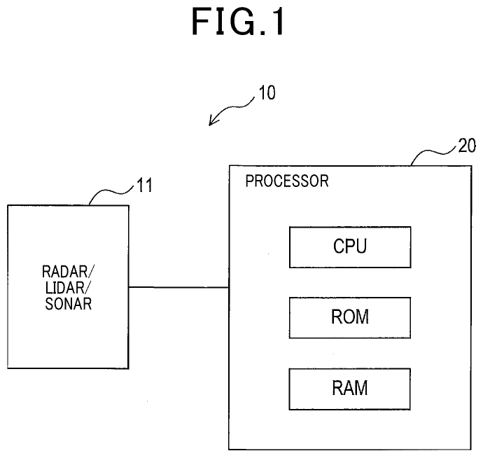

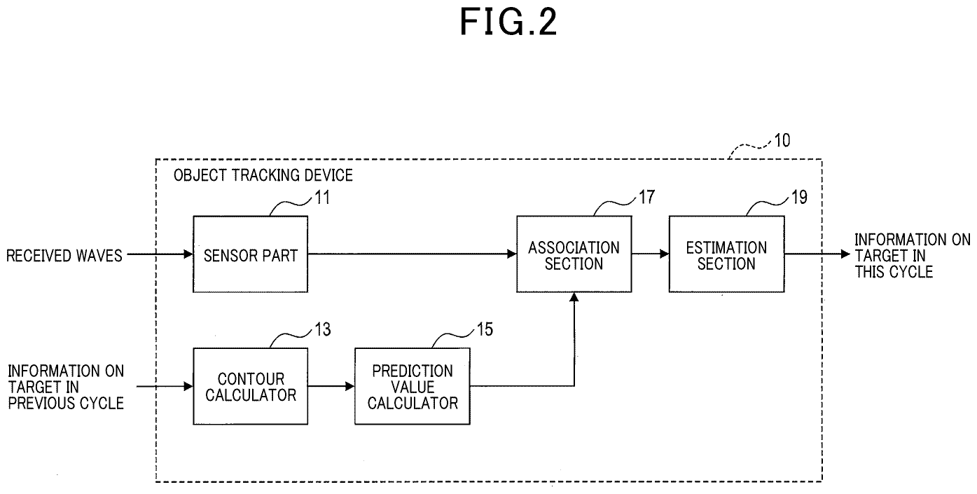

With reference to FIGS. 1 and 2, a configuration of an object tracking device 10 according to the present embodiment will be described. The object tracking device 10 includes a sensor part 11 and a processor 20, and is mounted on a vehicle 50 as an automobile. The sensor part 11 may be a radar, a lidar, a sonar, or the like. The radar sends, as a sensor wave, a radio wave such as a millimeter wave and receives a reflected wave generated by the radar wave being reflected on an object. The lidar sends light as a sensor wave and receives a reflected wave generated by the light being reflected on an object. The sonar sends a sound wave as a sensor wave and receives a reflected wave generated by the sound wave being reflected on an object.

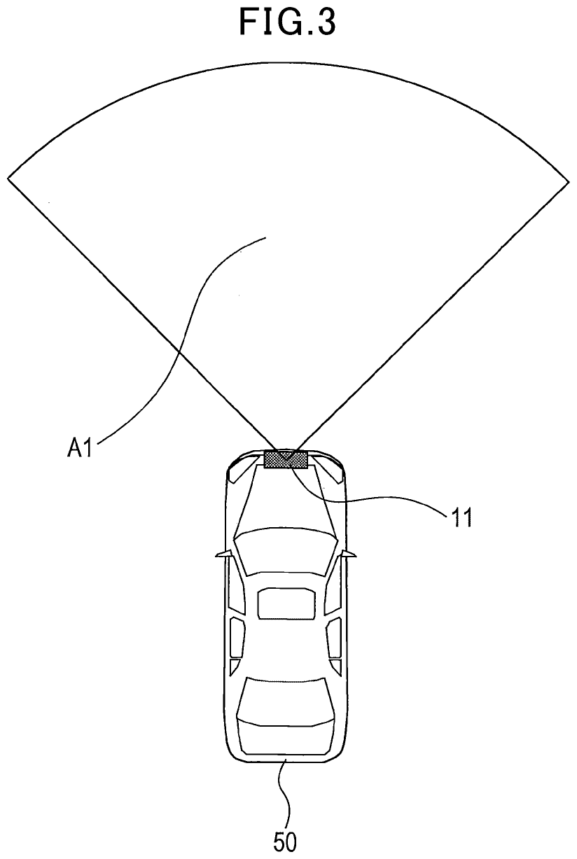

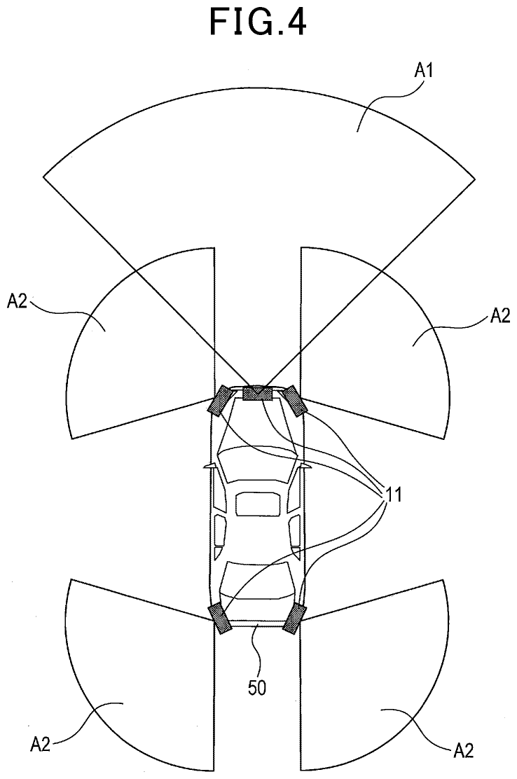

As illustrated in FIG. 3, the sensor part 11 may be mounted in a center front of the vehicle 50 (e.g., the center of the front bumper) and have a detection area A1 of the center front of the vehicle 50. Alternatively, as illustrated in FIG. 4, the sensor part 11 may be mounted in, in addition to the center front of the vehicle 50, a left front, a right front, a left rear, and a right rear of the vehicle 50 (e.g., a left end and a right end of the front bumper and a left end and a right end of the rear bumper). That is, the sensor part 11 may have, in addition to the detection area A1, detection areas A2 of the left front, the right front, the left rear, and the right rear of the vehicle 50. The sensor part 11 only needs to be mounded in at least one location among the center front, the left front, the right front, the left rear, and the right rear of the vehicle 50.

The processor 20 includes a micro-computer including a CPU, a ROM, a RAM, and the like. The processor 20 achieves functions of a contour calculator 13, a prediction value calculator 15, an association section 17, and an estimation section 19 by the CPU executing a program stored in a non-transitory tangible recording medium. The processor 20 has the various functions and thereby performs a tracking process of estimating the motion state of an object in chronological order. The various functions will be described later in detail. In the present embodiment, the ROM corresponds to the non-transitory tangible recording medium. A part or all of the various functions achieved by the processor 20 may be achieved by hardware including a combination of a logic circuit, an analog circuit, and the like.

### 2. Process

### <2-1. Tracking Process>

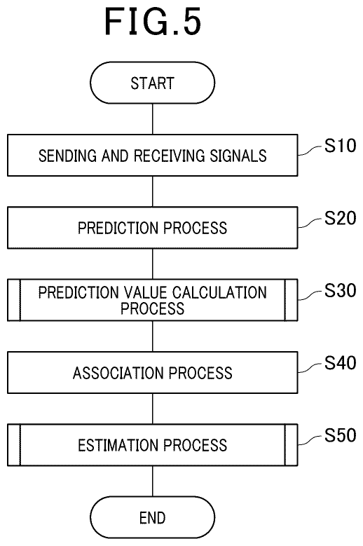

With reference to the flowchart in FIG. 5, a tracking process performed by the object tracking device 10 will be described. The object tracking device 10 repetitively performs the tracking process in prescribed process cycles.

In S10, as illustrated in FIG. 9, the sensor part 11 sends sensor waves to around the vehicle 50 and receives reflected waves generated by the sensor waves being reflected on an object. Then, the sensor part 11 acquires a plurality of observed values P3 based on the reflected waves received. The sensor part 11 is a high-resolution sensor, and can acquire, by one-time sending of sensor waves, a plurality of reflected waves that have been reflected at mutually different reflection positions (that is, reflection points) of a single object and acquire observed values P3 based on the reflected waves. Accordingly, the plurality of observed values P3 correspond to the mutually different reflection positions of the single object in one-to-one correspondence. Each of the plurality of observed values P3 includes a reflection position (specifically, the distance from the sensor part 11 to the reflected point, and the orientation of the reflection point with respect to the sensor part 11) as a physical quantity. Each of the plurality of observed values P3 may also include, in addition to the reflection position, relative speed as a physical quantity.

Subsequently, in S20, the contour calculator 13 performs a prediction process and calculates a predicted contour L1 of a target. The predicted contour L1 is a prediction value for the contour of a modelized shape of a target.

As described above, the sensor part 11 can obtain a plurality of observed values P3 from a single object. From the distribution of the plurality of observed values P3, a shape of the object can be estimated. Accordingly, the object tracking device 10 can produce a target having a shape as well as a motion state, based on the plurality of observed values P3. The shape referred to herein is different from a mass point having no area, and has an area. The object tracking device 10 performs extended object tracking (hereinafter, EOT) using a shape model of an object. The extended object tracking is a method of modeling a target assuming that the target has a shape, and estimating the motion state of the target in chronological order.

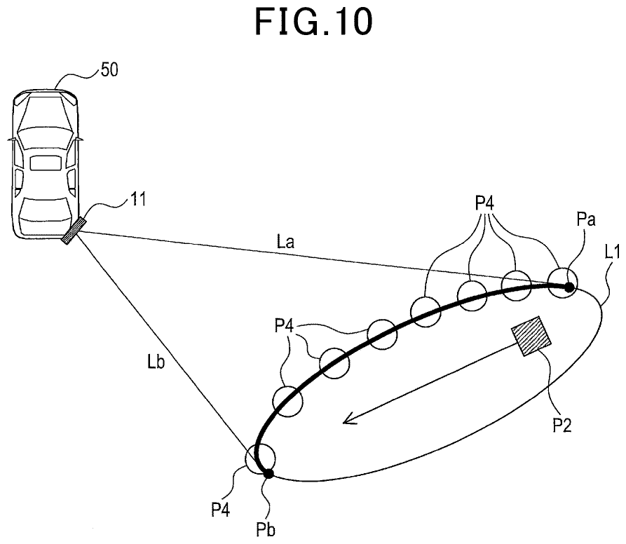

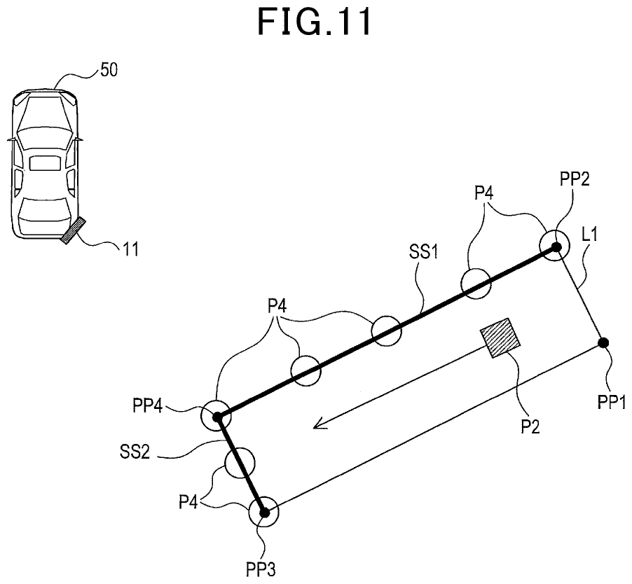

As illustrated in FIG. 9, the contour calculator 13 calculates a predicted contour L1 based on a predetermined shape model of an object and an estimation value P2 calculated in a past process cycle (specifically, a previous process cycle). In the present embodiment, an object tracked by the object tracking device 10 is a automobile (specifically, a four-wheel vehicle). Accordingly, the contour calculator 13 uses, as the shape model of an object, for example, a circular model, an elliptic model illustrated in FIG. 10, or a rectangular model illustrated in FIG. 11. Alternatively, the contour calculator 13 may estimate the size and the shape of the target from the distribution of the plurality of observed values P3, and select and use an appropriate model from a plurality of models prepared in advance.

The estimation value P2 is a value obtained by estimating the state of the target. The state of the target includes the position and the direction of the target. The estimation value P2 has at least one physical quantity of a reference point of the target. The object tracking device 10 calculates the estimation value P2 by estimating the motion state of the reference point in chronological order based on the plurality of observed value P3, a plurality of prediction values P4, the shape model, and a prescribed filter. The prescribed filter is, for example, a Kalman filter. The estimation value P2 includes, for example, positions in a x direction and a y direction of the reference point, speed, a traveling direction, and angular velocity. The x direction corresponds to a length direction of the vehicle 50, and the y direction corresponds to a width direction of the vehicle 50.

In the present embodiment, the reference point is the center of a rear-wheel shaft of the automobile. The contour calculator 13 calculates the predicted contour L1, which is the shape of the target, in this process cycle based on the estimation value P2 in the past and the shape model. The interior of the predicted contour L1 corresponds to a target presence area predicted in this process cycle. That is, the contour calculator 13 predicts the target presence area in this process cycle based on the estimation value P2 in the past and the shape model. Accordingly, the predicted contour L1 is highly likely to be calculated in the vicinity of the plurality of observed values P3 acquired in S10.

Subsequently, in S30, the prediction value calculator 15 performs a prediction value calculation process and calculates, independently from the plurality of observed values P3, a plurality of prediction values P4 located on and/or in the predicted contour L1 calculated in S20. That is, the prediction value calculator 15 calculates the plurality of prediction values P4 on and/or in the predicted contour L1 by a calculation method independent of the plurality of observed values P3 (that is, separately from the plurality of observed values P3).

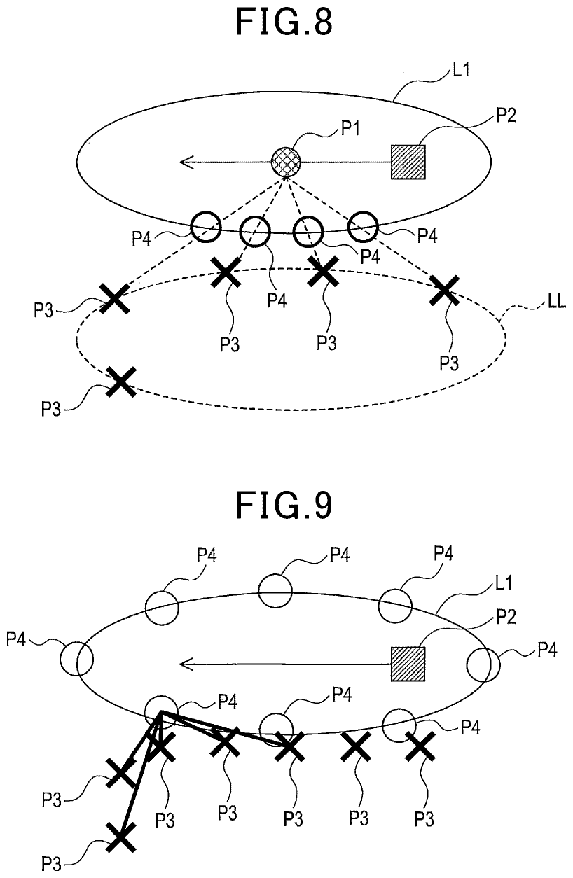

In a reference example illustrated in FIG. 8, the calculation of a plurality of prediction values P4 depends on a plurality of observed value P3. Specifically, in the reference example, lines are drawn that pass a center point P1 and the plurality of observed values P3 in one-to-one correspondence with the lines, assuming that the reflection of sensor waves is generated on the contour of a target. Then, intersections between the lines and a predicted contour L1 are calculated as prediction values P4, and a prediction value P4 and an observed value P3 on the same line are associated with each other. The center point P1 is the center of the predicted contour L1.

When the predicted contour L1 is, as illustrated in FIG. 8, shifted from an actual contour LL of the target, a prediction value 4 is associated with an observed value P3 not corresponding to the prediction value 4. In FIG. 8, prediction values P4 on the left side of the vehicle are associated with observed values P3 on the right side of the vehicle. When the plurality of prediction values P4 are calculated based on the plurality of observed values P3, once incorrect association is generated, the incorrect association may possibly continue. This may possibly lead to the decrease of accuracy of calculating the estimation value P2. That is, the object tracking accuracy may possibly be decreased.

Therefore, in the present embodiment, the prediction value calculator 15 calculates, independently from the plurality of observed values P3, the plurality of prediction values P4 located in a prescribed region on and/or in the predicted contour L1. The prediction value calculation process will be described later in detail.

Subsequently, in S40, the association section 17 associates each of the plurality of prediction values P4 calculated in S30 with one or two or more of the plurality of observed values P3 acquired in S10. In the present embodiment, the association section 17 associates each of the plurality of prediction values P4 with two or more of the plurality of observed values P3, and thus produces a plurality of association sets. In detail, the association section 17 associates one prediction value P4 with two or more observed values P3 located in a setting range of the prediction value P4, and thus produces one association set. Accordingly, each of the association sets includes one prediction value P4 and two or more observed values P3 associated with the prediction value P4. Thus, by allowing two or more types of association for one prediction value P4, the two or more types of association are highly likely to include correct association. Therefore, by allowing a plurality of types of association, the estimation value P2 is affected by correct association during object tracking, and settles into a correct value. When the association section 17 associates one prediction value P4 with one prediction value P3 and the association is incorrect, the incorrect association may possibly persist.

Subsequently, in S50, the estimation section 19 performs an estimation process by applying a filter, such as a Kalman filter, to the plurality of association sets calculated in S40, and calculating the current estimation value P2. The estimation process will be described later in detail.

### <2-2. Prediction Value Calculation Process>

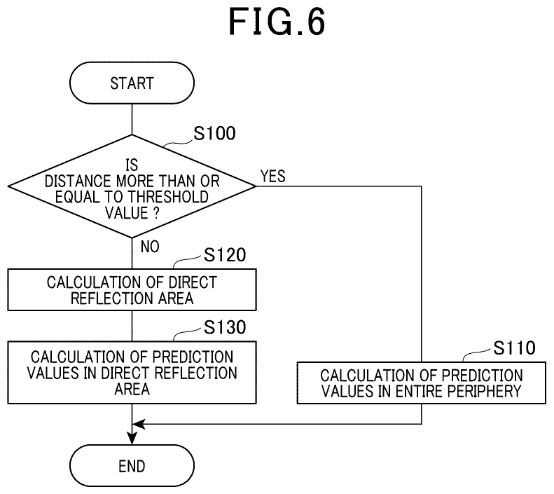

Next, with reference to the flowchart in FIG. 6, the prediction value calculation process performed by the prediction value calculator 15 will be described in detail.

In S100, the prediction value calculator 15 determines whether the distance to the target is more than or equal to a threshold value. The distance referred to herein is the distance of the estimation value P2 calculated in the previous process cycle, or the distance calculated based on the position of the estimation value P2. Alternatively, the distance referred to herein may be the distance calculated based on the plurality of observed values P3 acquired in S10.

When the target is present far from the sensor part 11, variation in position of the reflection points of the object is great and the reflection points are widely distributed in the entire area of the object. Therefore, when the target is present far from the sensor part 11 and the prediction value calculator 15 calculates the plurality of prediction values P4 located in the prescribed region on and/or in the predicted contour L1, narrowing the prescribed region may possibly decrease the accuracy of association between one prediction value P4 and two or more observed values P3. This may possibly lead to the decrease of accuracy of calculating the estimation value P2.

On the other hand, when the target is present in the vicinity of the sensor part 11, variation in position of the reflection points of the object is small and the reflection points are intensively distributed in a specific area of the object. Therefore, when the target is present in the vicinity of the sensor part 11 and the prediction value calculator 15 calculates the plurality of prediction values P4 located in the prescribed region on and/or in the predicted contour L1, broadening the prescribed region may possibly decrease the accuracy of association between one prediction value P4 and two or more observed values P3. This may possibly lead to the decrease of accuracy of calculating the estimation value P2.

Therefore, the prediction value calculator 15 changes the prescribed region according to the distance to the target. When the prediction value calculator 15 determines in S100 that the distance is more than or equal to the threshold value, the prediction value calculation process proceeds to the process in S110. When the prediction value calculator 15 determines that the distance is less than the threshold value, the prediction value calculation process proceeds to the process in S120.

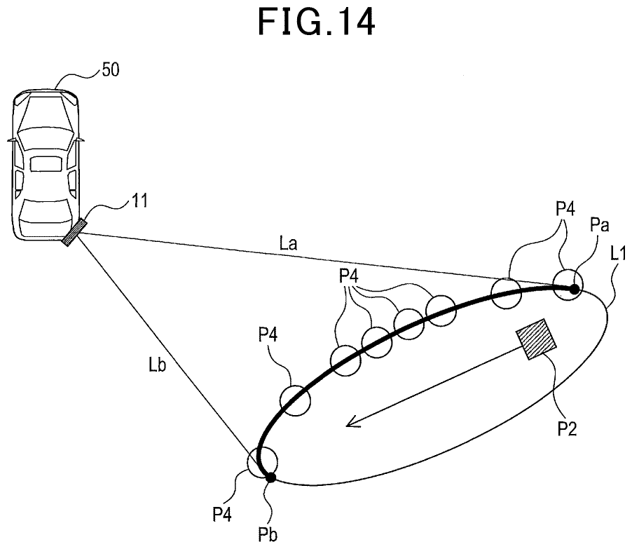

In S110, as illustrated in FIG. 9, the prediction value calculator 15 sets the entire periphery of the predicted contour L1 as the prescribed region. Then, the prediction value calculator 15 calculates the plurality of prediction values P4 at predetermined positional intervals in the prescribed region. Each of the plurality of prediction values P4 has coordinate values on the predicted contour L1. The predetermined positional intervals may be equal intervals. Alternatively, the predetermined positional intervals may be smaller the closer to the center of the prescribed region so that the closer to the center of the prescribed region, the more prediction values P4 contribute to the update of the estimation value P2 (see FIG. 14).

In S120, the prediction value calculator 15 calculates a direct reflection area in the predicted contour L1. The direct reflection area corresponds to an area to which the sensor part 11 can directly irradiate sensor waves.

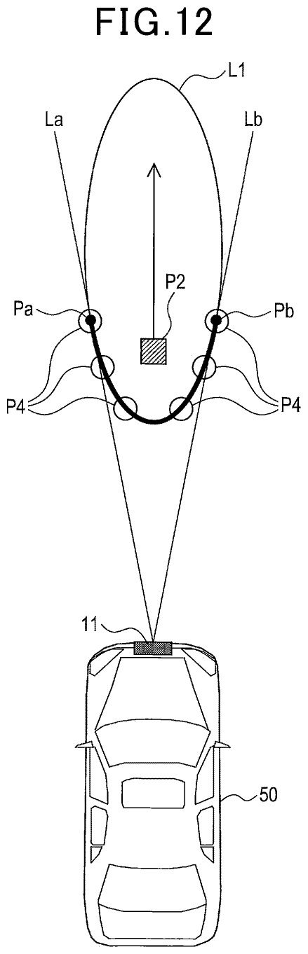

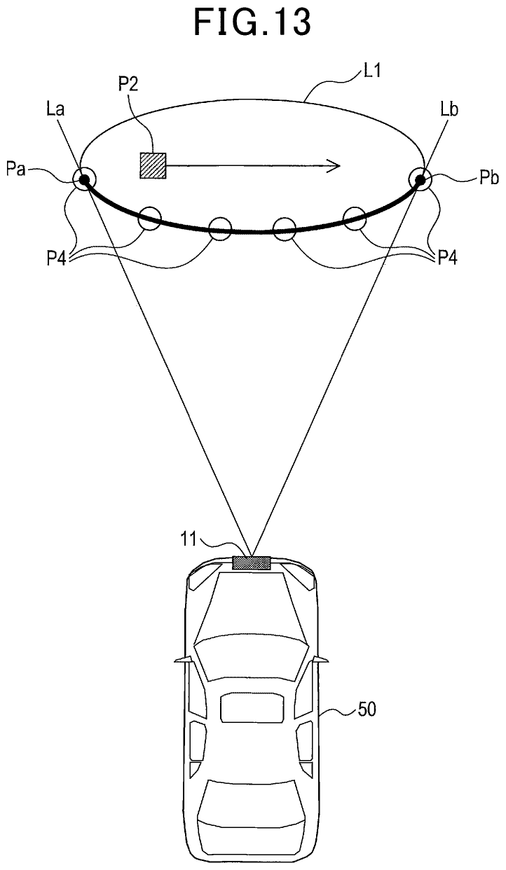

When, as illustrated in FIG. 10, the shape model is an elliptic model or a circular model, the prediction value calculator 15 calculates, as the direct reflection area, an area nearer to the sensor part 11 between two areas situated between a first point Pa and a second point Pb. The first point Pa is a point on the predicted contour L1, and is a tangent point between a first tangent line La passing the sensor part 11 and the shape model. The second point Pb is a point on the predicted contour L1 but different from the first point Pa, and is a tangent point between a second tangent line Lb passing the sensor part 11 and the shape model. FIG. 12 illustrates the direct reflection area designated when the sensor part 11 irradiates sensor waves to a rear of an object (specifically, a vehicle). FIG. 13 illustrates the direct reflection area designated when the sensor part 11 irradiates sensor waves to a side of the object.

Alternatively, when, as illustrated in FIG. 11, the shape model is a rectangular model having a first vertex PP1, a second vertex PP2, a third vertex PP3, and a fourth vertex PP4, a first side SS1, and a second side SS2, the prediction value calculator 15 calculates the first and second sides SS1 and SS2 as the direct area. The first vertex PP1 is the farthest vertex from the sensor part 11 among the four vertexes of the rectangular model. The second and third vertexes PP2 and PP3 are two vertexes adjacent to the first vertex PP1. The fourth vertex PP4 is a vertex between the second and third vertexes PP2 and PP3 but different from the first vertex PP1. The first side SS1 connects the fourth vertex PP4 to the second vertex PP2. The second side SS2 connects the fourth vertex PP4 to the third vertex PP3.

In S130, the prediction value calculator 15 sets the direct reflection area as the prescribed region and calculates the plurality of prediction values P4 at the certain positional intervals in the prescribed region. As illustrated in FIGS. 10 and 11, the certain positional intervals may be equal intervals. Alternatively, as illustrated in FIG. 14, the predetermined positional intervals may be smaller the closer to the center of the prescribed region so that the closer to the center of the prescribed region, the more prediction values P4 contribute to the estimation value P2.

### <2-3. Estimation Process>

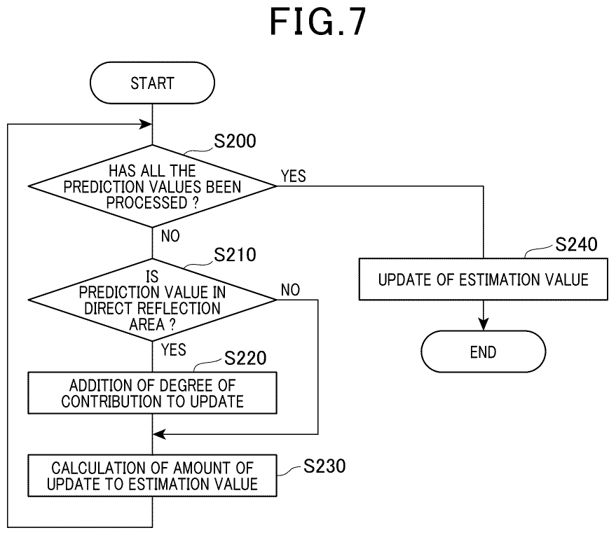

Next, with reference to the flowchart in FIG. 7, the estimation process performed by the estimation section 19 will be described in detail.

In S200, the estimation section 19 determines whether the following subsequent processes in S210 to S230 have been performed on all the prediction values P4 calculated in S20. When the estimation section 19 determines that the processes in S210 to S230 have not been performed on all the prediction values P4, the estimation section 19 selects one of the prediction values P4 determined not to have the processes in S210 to S230 performed thereon and the estimation process proceeds to the process in S210. When the estimation section 19 determines that the processes in S210 to S230 have been performed on all the prediction values P4, the estimation process proceeds to the process in S240.

In S210, the estimation section 19 determines whether the prediction value P4 selected in S200 is located in the direct reflection area. When the entire periphery of the predicted contour L1 is set as a prescribed region, the prescribed region includes the direct reflection area and a non-direct reflection area. The non-direct reflection area is an area to which the sensor part 11 cannot directly irradiate sensor waves. When the estimation section 19 determines that the selected prediction value P4 is located in the direct reflection area, the estimation process proceeds to the process in S220. When the estimation section 19 determines that the selected prediction value P4 is located in the non-direct reflection area, the estimation process jumps the process in S220 and proceeds to the process in S230.

In S220, the estimation section 19 makes the degree of contribution of the selected prediction value P4 to the update of the estimation value P2 higher than a reference value. For example, the estimation section 19 increases the degree of contribution by adding a prescribed value to the reference value for the decree of contribution. When the selected prediction value P4 is located in the non-direct reflection area, the degree of contribution of the selected prediction value P4 is the reference value. An association set including a prediction value P4 located in the direct reflection area has higher reliability than the reliability of an association set including a prediction value P4 located in the non-direct reflection area. Therefore, the estimation section 19 increases the degree of contribution to the update of the estimation value P2 when the selected prediction value P4 is located in the direct reflection area.

In S230, the estimation section 19 calculates the amount of the update of the estimation value P2 made by an observed value associated with the selected prediction value P4. Specifically, the estimation section 19 calculates the amount of the update, using, for example, an extended Kalman filter that is a non-linear filter.

In S240, the estimation value P2 is updated by weight-averaging, according to the degree of contribution, the amounts of the update of the estimation value P2 calculated for the prediction values P4, followed by adding. The updated estimation value P2 is the estimation value P2 in this process cycle.

### 3. Effects

The first embodiment described above in detail exhibits the following effects.
(1) In the object tracking device 10, a plurality of prediction values P4 are calculated independently from a plurality of observed values P3. Accordingly, continuation of incorrect association between a prediction value P4 and at least one observed value P3 is suppressed, and the decrease of accuracy of estimating the position of a target can be suppressed.
(2) One prediction value P4 is associated with a plurality of observed values P3. By allowing a plurality of types of association for one prediction value P4, the plurality of types of association include correct association, enabling settling of the estimated position of a target into a correct observed position. This can lead to improvement of the accuracy of estimating the position of a target.
(3) When the plurality of prediction values P4 are calculated at predetermined positional intervals in the prescribed region, the process of calculating the plurality of prediction values P4 can be facilitated.
(4) When the plurality of prediction values P4 are calculated at equal positional intervals in the prescribed region, the process of calculating the plurality of prediction values P4 can be facilitated.
(5) More observed values P3 are more likely to be obtained closer to the center of the prescribed region. Accordingly, by more densely calculating the prediction values P4 closer to the center in the prescribed region, the accuracy of estimating the position of a target can be improved.
(6) Many observed values P3 can be obtained from the direct reflection area. Accordingly, by setting the direct reflection area as the prescribed region, the accuracy of estimating the position of a target can be improved.
(7) When a circular model or an elliptic model is used as the shape model, the direct reflection area can easily be calculated by performing the calculation, with an area between the first and second points Pa and Pb set as the direct reflection area.
(8) When a rectangular model is used as the shape model, the direct reflection area can easily be calculated by performing the calculation, with the first and second sides SS1 and SS2 set as the direct reflection area.
(9) When the entire periphery is set as the prescribed region, the degree of contribution of a prediction value P4 in the direct reflection area to the update of the estimation value P2 is calculated higher than the degree of contribution of a prediction value P4 in the non-direct reflection area to the update of the estimation value P2. Thereby, the accuracy of estimating the position of a target can be improved.
(10) When the target is far from the sensor part 11, the entire periphery of the predicted contour L1 is set as the prescribed region. When the target is in the vicinity of the sensor part 11, the direct reflection area is set as the prescribed region. Thereby, the position of the target, which is located in the vicinity of or far from the sensor part 11, can accurately be estimated.

### Second Embodiment

### 1. Differences from the First Embodiment

The second embodiment has the same basic configuration as the first embodiment, and therefore, differences will be described below. The same reference sign as in the first embodiment indicates the identical configuration, and the preceding description is to be referred to.

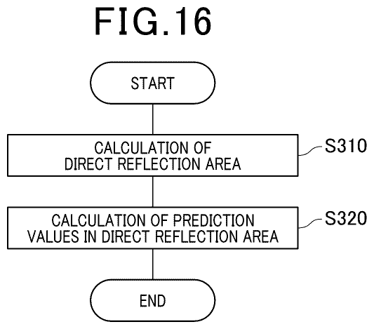

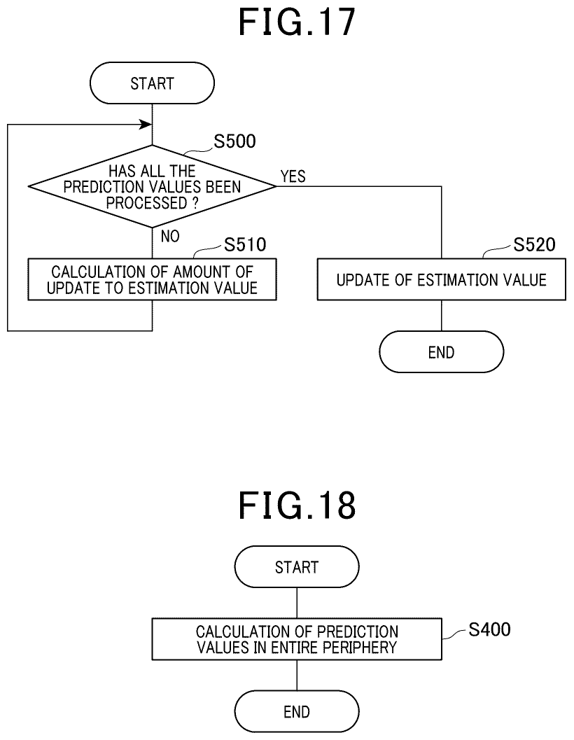

In the first embodiment, the prescribed region is changed according to the distance to the target. In contrast, the second embodiment is different from the first embodiment in that the prescribed region is set regardless of the distance to the target. Specifically, in the second embodiment, the prediction value calculator 15 sets the direct reflection area as the prescribed region regardless of the distance to the target. The estimation section 19 calculates the estimation value P4 without considering the degree of contribution of a prediction value P4 to the update of the estimation value P2. Accordingly, in the second embodiment, the prediction value calculator 15 performs the flowchart in FIG. 16 instead of the flowchart in FIG. 6. In addition, in the second embodiment, the estimation section 19 performs the flowchart in FIG. 17 instead of the flowchart in FIG. 7.

### 2. Process

### <2-1. Prediction Value Calculation Process>

With reference to the flowchart in FIG. 16, the prediction value calculation process performed by the prediction value calculator 15 will be described.

In S310, the prediction value calculator 15 calculates, similarly to S120, a direct reflection area in the predicted contour L1.

Subsequently, in S320, the prediction value calculator 15 sets, similarly to S130, the direct reflection area as a prescribed region and calculates a plurality of prediction values P4 at predetermined positional intervals in the prescribed region. That is, in the present embodiment, the prediction value calculator 15 calculates the plurality of prediction values P4 in the direct reflection area regardless of the distance to the target.

### <2-2. Estimation Process>

Next, with reference to the flowchart in FIG. 17, the estimation process performed by the estimation section 19 will be described.

In S500, the estimation section 19 determines, similarly to S200, whether the following subsequent process in S510 has been performed on all the prediction values P4 calculated in S20. When the estimation section 19 determines that the process in S510 has not been performed on all the prediction values P4, the estimation section 19 selects one of the prediction values P4 determined not to have the process in S510 performed thereon and the estimation process proceeds to the process in S510. When the estimation section 19 determines that the process in S510 has been performed on all the prediction values P4, the estimation process proceeds to the process in S520.

In S510, the estimation section 19 calculates, similarly to S230, the amount of the update of the estimation value P2 made by an observed value associated with the selected prediction value P4.

In S520, the estimation section 19 averages the amounts of the update of the estimation value P4 calculated for the prediction values P4 and updates the estimation value P2. That is, in the present embodiment, the estimation section 19 homogenizes the weight of all the prediction values P4 and updates the estimation value P2.

The second embodiment described above exhibits the same effects as the effects (1) to (8) described above.

### Third Embodiment

### 1. Differences from the Second Embodiment

The third embodiment has the same basic configuration as the second embodiment, and therefore, differences will be described below. The same reference sign as in the second embodiment indicates the identical configuration, and the preceding description is to be referred to.

In the second embodiment, the direct reflection area is set as the prescribed region regardless of the distance to the target. In contrast, the third embodiment is different from the second embodiment in that the prescribed region is fixed to the entire periphery of the predicted contour L1 regardless of the distance to the target. The estimation section 19 calculates the estimation value P4 without considering the degree of contribution of a prediction value P4 to the update of the estimation value P2. Accordingly, in the third embodiment, the prediction value calculator 15 performs the flowchart in FIG. 18 instead of the flowchart in FIG. 16 Meanwhile, in the third embodiment, the estimation section 19 performs the flowchart in FIG. 17 similarly to the second embodiment.

### 2. Prediction Value Calculation Process

With reference to the flowchart in FIG. 18, the prediction value calculation process performed by the prediction value calculator 15 will be described.

In S400, the prediction value calculator 15 sets the entire periphery of the predicted contour L1 as a prescribed region and calculates a plurality of prediction values P4 at predetermined positional intervals in the prescribed region. That is, in the present embodiment, the prediction value calculator 15 calculates the plurality of prediction values P4 on the entire periphery of the predicted contour L1 regardless of the distance to the target.

The third embodiment described above exhibits the same effects as the effects (1) to (5) and (9) described above and also exhibits the following effects (11) and (12).
(11) The fixation of the prescribed region facilitates the calculation process of the plurality of prediction values P4.
(12) By setting the entire periphery of the predicted contour L1 as the prescribed region, the estimated position of the target can be prevented from being greatly deviated from the true position of the target.

### Other Embodiments

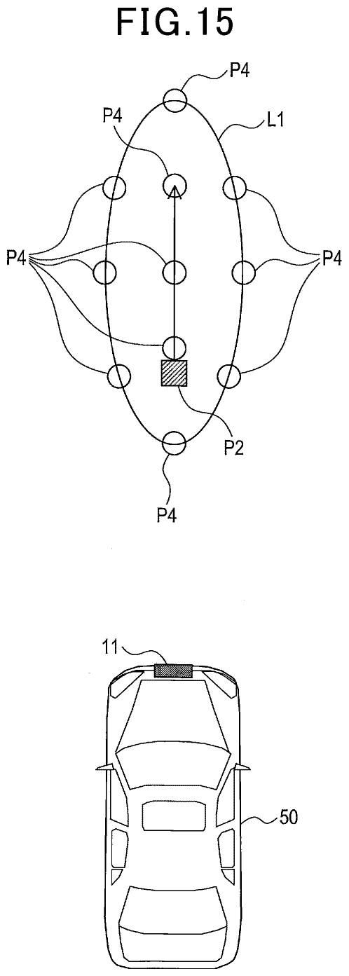

While the embodiments of the present disclosure have been described heretofore, the present disclosure is not limited to the embodiments, and can be carried out with various modifications.
(a) When the entire periphery of the predicted contour L1 is set as the predetermined prescribed region, the degree of contribution of a prediction value P4 in the direct reflection area to the update of the estimation value P2 may be made higher than the degree of contribution of a prediction value P4 in the non-direct reflection area to the update of the estimation value P2. Alternatively, a region(s) corresponding to one or two or more tires on the predicted contour L1 may be set as the predetermined prescribed region(s). A tire tends to produce many reflection points, and therefore, setting, as the prescribed region, a region corresponding to a tire enables accurate estimation of the position of the target.
(b) In an embodiment described above, the prediction value calculator 15 changes the prescribed region according to the distance to the target. However, the prescribed region may be changed according to the state of the target. When the sensor part 11 irradiates sensor waves to a side of a tracked vehicle, few observed values P3 corresponding to reflection positions in the vehicle are acquired. On the other hand, when the sensor part 11 irradiates sensor waves to a rear of a tracked vehicle, relatively many observed values P3 corresponding to reflection positions in the vehicle are acquired. Therefore, the prediction value calculator 15 may change the prescribed region according to the direction of a tracked vehicle. For example, as illustrated in FIG. 15, the prediction value calculator 15 may set the prescribed region on or in the predicted contour L1 when the sensor part 11 irradiates sensor waves to a rear of a tracked vehicle. On the other hand, the prediction value calculator 15 may set the prescribed region only on the predicted contour L1 when the sensor part 11 irradiates sensor waves to a side of a tracked vehicle. By dynamically setting the prescribed region according to the state of the target, the accuracy of estimating the position of the target can be improved.
(c) In the embodiments, the object tracking device 10 is mounted on an automobile. However, the object tracking device 10 may be mounted on a mobile object other than automobiles. For example, the object tracking device 10 may be mounted on a mobile object such as a train, a vessel, an aircraft, a motorcycle, and a drone.
(d) The object tracking device 10 and the methods thereof described in the present disclosure may be achieved by a dedicated computer provided so as to include a processor, which has been programmed to perform one or a plurality of functions embodied by a computer program, and a memory. Alternatively, the object tracking device 10 and the methods thereof described in the present disclosure may be achieved by a dedicated computer provided so as to include a processor formed of one or more dedicated hardware logic circuits. Alternatively, the object tracking device 10 and the methods thereof described in the present disclosure may be achieved by one or more dedicated computers configured to include a combination of a processor, which has been programmed to perform one or a plurality of functions, and a memory, with a processor formed of one or more hardware logic circuits. The computer program may be, as an instruction to be performed by a computer, stored in a computer-readable non-transitory tangible recording medium. The methods of achieving the functions of the components included in the object tracking device 10 do not necessarily include software, and all the functions may be achieved by one or a plurality of hardware components.
(e) A plurality of functions of one constituent element in the embodiments may be achieved by a plurality of constituent elements, whereas one function of one constituent element may be achieved by a plurality of constituent elements. Alternatively, a plurality of functions of a plurality of constituent elements may be achieved by one constituent element, whereas one function achieved by a plurality of constituent elements may be achieved by one constituent element. A part of the configurations in the embodiments may be omitted. At least a part of the configurations in an embodiment described above may be added to or replaced for a configuration of another embodiment described above.
(f) The present disclosure can be achieved by the object tracking device 10 described above, and also by various forms such as a system including the object tracking device 10 as a constituent element, a program for functioning a computer as the object tracking device, a non-transitory tangible recording medium, e.g., a semiconductor memory having this program stored therein, and an object tracking method.

### Technical Ideas Disclosed in the Present Description

### Item 1

An object tracking device including:
a sensor part (11) mounted to a mobile object (50) and configured to send and receive a sensor wave to and from around the mobile object, and acquire a plurality of observed values that correspond to mutually different reflection positions;
a contour calculator (13) configured to calculate a predicted contour based on a predetermined shape model of an object and an estimation value calculated in the past, the estimation value being an estimated value that represents a state of a target including a position and a direction of the object, and the predicted contour being a predicted value representing a current contour of the target;
a prediction value calculator (15) configured to calculate a plurality of prediction values located in a prescribed region on and/or in the predicted contour, independently from the plurality of observed values acquired by the sensor part;
an association section (17) configured to associate each of the plurality of prediction values with at least one of the plurality of observed values, and produce a plurality of association sets; and
an estimation section (19) configured to calculate the current estimation value based on the plurality of association sets produced by the association section.

### Item 2

The object tracking device according to item 1, wherein
the association section is configured to associate each of the plurality of prediction values with two or more of the plurality of observed values, and
each of the plurality of association sets includes one of the plurality of prediction values and two or more of the plurality of observed values.

### Item 3

The object tracking device according to item 1 or 2, wherein
the prescribed region is predetermined.

### Item 4

The object tracking device according to item 1 or 2, wherein
the prediction value calculator is configured to set the prescribed region according to a state of the target.

### Item 5

The object tracking device according to any one of items 1 to 4, wherein
the prediction value calculator is configured to calculate the plurality of prediction values at predetermined positional intervals in the prescribed region.

### Item 6

The object tracking device according to any one of items 1 to 5, wherein
the prediction value calculator is configured to calculate the plurality of prediction values at equal positional intervals in the prescribed region.

### Item 7

The object tracking device according to any one of items 1 to 6, wherein
the prediction value calculator is configured to calculate the plurality of prediction values such that positional intervals between the plurality of prediction values decrease as they approach a center of the prescribed region.

### Item 8

The object tracking device according to any one of items 1 to 7, wherein
the prescribed region is an entire periphery of the predicted contour.

### Item 9

The object tracking device according to any one of items 1, 2, and 4 to 7, wherein
the prescribed region is a region to which the sensor part directly irradiates the sensor wave.

### Item 10

The object tracking device according to item 9, wherein
the shape model is a circular model or an elliptic model,
the prescribed region is an area nearer to the sensor part between areas situated between a first point and a second point on the predicted contour,
the first point is a tangent point between a first tangent line and the predicted contour, the first tangent line passing the sensor part and touching the predicted contour, and
the second point is a tangent point between a second tangent line and the predicted contour, and is a point different from the first point, the second tangent line passing the sensor part and touching the predicted contour.

### Item 11

The object tracking device according to item 9, wherein
the shape model is a rectangular model having a first vertex, a second vertex, a third vertex, a fourth vertex, a first side, and a second side, the first vertex being farthest from the sensor part, the second and third vertexes being adjacent to the first vertex, the fourth vertex being located between the second and third vertexes, the first side connecting the fourth vertex to the second vertex, and the second side connecting the fourth vertex to the third vertex, and
the prescribed region includes the first and second sides.

### Item 12

The object tracking device according to item 8, wherein
the prescribed region includes a first region to which the sensor part directly irradiates the sensor wave, and a second region to which the sensor part does not directly irradiate the sensor wave,
the plurality of prediction values include a first prediction value in the first region and a second prediction value in the second region, and
the estimation section is configured to make a first degree of contribution higher than a second degree of contribution, the first degree of contribution being a degree of contribution of the first prediction value to update of the estimation value, and the second degree of contribution being a degree of contribution of the second prediction value to update of the estimation value.

### Item 13

The object tracking device according to any one of items 1 to 12, wherein
the prediction value calculator is configured to change the prescribed region according to a distance to the target.

### Item 14

The object tracking device according to item 13, wherein
the prediction value calculator is configured to:
set an entire periphery of the predicted contour as the prescribed region when the distance to the target is more than or equal to a prescribed distance, and
set, as the prescribed region, a region to which the sensor part directly irradiates the sensor wave when the distance to the target is less than the prescribed distance.

What is claimed is:

1. An object tracking device comprising:
a sensor part mounted to a mobile object and configured to send and receive a sensor wave to and from around the mobile object, and acquire a plurality of observed values that correspond to mutually different reflection positions;
a contour calculator configured to calculate a predicted contour based on a predetermined shape model of an object and an estimation value calculated in the past, the estimation value being an estimated value that represents a state of a target including a position and a direction of the object, and the predicted contour being a predicted value representing a current contour of the target;
a prediction value calculator configured to calculate a plurality of prediction values located in a prescribed region on and/or in the predicted contour, independently from the plurality of observed values acquired by the sensor part;
an association section configured to associate each of the plurality of prediction values with at least one of the plurality of observed values, and produce a plurality of association sets; and
an estimation section configured to calculate the current estimation value based on the plurality of association sets produced by the association section.

2. The object tracking device according to claim 1, wherein
the association section is configured to associate each of the plurality of prediction values with two or more of the plurality of observed values, and
each of the plurality of association sets includes one of the plurality of prediction values and two or more of the plurality of observed values.

3. The object tracking device according to claim 1, wherein
the prescribed region is predetermined.

4. The object tracking device according to claim 1, wherein
the prediction value calculator is configured to set the prescribed region according to a state of the target.

5. The object tracking device according to claim 1, wherein
the prediction value calculator is configured to calculate the plurality of prediction values at predetermined positional intervals in the prescribed region.

6. The object tracking device according to claim 1, wherein
the prediction value calculator is configured to calculate the plurality of prediction values at equal positional intervals in the prescribed region.

7. The object tracking device according to claim 1, wherein
the prediction value calculator is configured to calculate the plurality of prediction values such that positional intervals between the plurality of prediction values decrease as they approach a center of the prescribed region.

8. The object tracking device according to claim 5, wherein
the prescribed region is an entire periphery of the predicted contour.

9. The object tracking device according to claim 5, wherein
the prescribed region is a region to which the sensor part directly irradiates the sensor wave.

10. The object tracking device according to claim 9, wherein
the shape model is a circular model or an elliptic model,
the prescribed region is an area nearer to the sensor part between areas situated between a first point and a second point on the predicted contour,
the first point is a tangent point between a first tangent line and the predicted contour, the first tangent line passing the sensor part and touching the predicted contour, and
the second point is a tangent point between a second tangent line and the predicted contour, and is a point different from the first point, the second tangent line passing the sensor part and touching the predicted contour.

11. The object tracking device according to claim 9, wherein
the shape model is a rectangular model having a first vertex, a second vertex, a third vertex, a fourth vertex, a first side, and a second side, the first vertex being farthest from the sensor part, the second and third vertexes being adjacent to the first vertex, the fourth vertex being located between the second and third vertexes, the first side connecting the fourth vertex to the second vertex, and the second side connecting the fourth vertex to the third vertex, and
the prescribed region includes the first and second sides.

12. The object tracking device according to claim 8, wherein
the prescribed region includes a first region to which the sensor part directly irradiates the sensor wave, and a second region to which the sensor part does not directly irradiate the sensor wave,
the plurality of prediction values include a first prediction value in the first region and a second prediction value in the second region, and
the estimation section is configured to make a first degree of contribution higher than a second degree of contribution, the first degree of contribution being a degree of contribution of the first prediction value to update of the estimation value, and the second degree of contribution being a degree of contribution of the second prediction value to update of the estimation value.

13. The object tracking device according to claim 1, wherein
the prediction value calculator is configured to change the prescribed region according to a distance to the target.

14. The object tracking device according to claim 13, wherein
the prediction value calculator is configured to:
set an entire periphery of the predicted contour as the prescribed region when the distance to the target is more than or equal to a prescribed distance, and
set, as the prescribed region, a region to which the sensor part directly irradiates the sensor wave when the distance to the target is less than the prescribed distance.
